(19) United States
(12) Patent Application Publication
(10) Pub. No.: US 2026/0329443 A1
(43) Pub. Date: Oct. 22, 2026

(54) STORAGE DEVICE AND DATA PROCESSING SYSTEM FOR SEPARATELY MANAGING ACCESS AREAS ACCORDING TO DATA TYPE

(71) Applicant: SK hynix Inc., Icheon-si (KR)

(72) Inventors: Hui Jae YU, Icheon-si (KR); Won Kyung KANG, Icheon-si (KR); Hyeong Ju NA, Icheon-si (KR); Jin Suk LEE, Icheon-si (KR); Sung Hyuk CHUNG, Icheon-si (KR); Jung Hyun JOH, Icheon-si (KR)

(21) Appl. No.: 19/336,659

(22) Filed: Sep. 23, 2025

(30) Foreign Application Priority Data
Apr. 21, 2025 (KR) 10-2025-0051565

(51) Int. Cl. G06F 3/06

(52) U.S. Cl. CPC G06F 3/0613; G06F 3/0644; G06F 3/0673

(57) ABSTRACT

A storage device includes a nonvolatile memory device comprising first and second storage areas, and a controller configured to manage first map information that separately maps first data, divided by a preset size unit, in order to access the first storage area by preset size units when access to the first data is requested, configured to manage N pieces of second map information that separately maps N second data, and configured to access the second storage area by a size of each of the N second data when access to the N second data is requested, wherein N is a natural number equal to or greater than 1.

### CROSS-REFERENCE TO RELATED APPLICATION

This application claims priority under 35 U.S.C. § 119(a) to Korean Patent Application No. 10-2025-0051565, filed in the Korean Intellectual Property Office on Apr. 21, 2025, the entire contents of which are incorporated herein by reference.

### BACKGROUND

### 1. Field

Exemplary embodiments relate to a storage device, and particularly, to a storage device for separately managing an access area according to a data type and a data processing system including the same.

### 2. Discussion of the Related Art

Recently, the computer environment paradigm has shifted to ubiquitous computing, which enables a computer system to be accessed anytime and everywhere. As a result, the use of portable electronic devices such as mobile phones, digital cameras, notebook computers and the like has increased. Such portable electronic devices typically use or include a storage device that uses or embeds at least one memory device, i.e., a data storage device. The data storage device can be used as a main storage device or an auxiliary storage device of a portable electronic device.

In a computing device, unlike a hard disk, a data storage device implemented as a nonvolatile semiconductor memory device is advantageous in that it has excellent stability and durability because it has no mechanical driving parts (e.g., a mechanical arm), and has high data access speed and low power consumption. Examples of such a data storage device include a universal serial bus (USB) memory device, a memory card having various interfaces, and a solid state drive (SSD).

Recently, interest in artificial intelligence (AI) is increasing rapidly in all industries, such as finance and healthcare, in addition to the information technology (IT) industry. Accordingly, in various fields, with the introduction of AI, deep learning has been considered and prototyped. In general, deep learning collectively refers to a technology in which deep neural networks (DNNs) or deep networks having increased numbers of layers from the existing neural networks are effectively trained and used in pattern recognition or inference.

As described above, as the interest in AI applications and big data analysis grows, and the importance of AI applications and big data analysis increases, there is increasingly a demand to efficiently process a large amount of data.

### SUMMARY

Various embodiments are directed to providing a storage device capable of physically dividing areas in which normal data and AI data are stored and separately managing an access area depending on the type of access target data, and a data processing system including the storage device.

The problems to be solved by the present disclosure are not limited to the above-mentioned problems, and the other unmentioned problems will be clearly understood from the following description by those skilled in the art.

An aspect of an embodiment in the disclosure, a storage device may include: a nonvolatile memory device comprising first and second storage areas; and a controller configured to manage first map information that separately maps first data, divided by a preset size unit, in order to access the first storage area by preset size units when access to the first data is requested, configured to manage N pieces of second map information that separately maps N second data, and configured to access the second storage area by a size of each of the N second data when access to the N second data is requested, wherein N may be a natural number equal to or greater than 1.

An aspect of an embodiment in the disclosure, a data processing system may include: a host configured to separately manage first data organized in units of a preset size and configured to separately manage N second data in which second data size varies; and a storage device comprising a nonvolatile memory device comprising first and second storage areas and a controller configured to manage first map information that separately maps the first data in preset size units to access the first storage area organized in units of the preset size when access to the first data is requested by the host, and configured to manage N pieces of second map information that separately map the N second data in order to access the second storage area by a size of each of the N second data when access to the N second data is requested by the host, wherein N may be a natural number equal to or greater than 1.

In the present technology, a storage space within a nonvolatile memory device can be divided into a first storage space in which normal data will be stored and a second storage space in which AI data will be stored. In particular, in the present technology, in order to guarantee sequential access to the AI data that are accessed in the second storage space, the AI data can be divided in a data unit and accessed in the second storage space.

Accordingly, the present technology can improve effective access to the AI data.

### BRIEF DESCRIPTION OF THE DRAWINGS

FIGS. 1A and 1B are diagrams each describing an example of a data processing system including a storage device according to embodiments of the present disclosure.

FIGS. 2A and 2B are diagrams for describing examples of operations of accessing, by the storage device, normal data according to an embodiment of the present disclosure.

FIGS. 3A and 3B are diagrams for describing examples of operations of accessing, by the storage device, AI data according to an embodiment of the present disclosure.

FIGS. 4A and 4B are diagrams for describing examples of operations of updating, by the storage device, AI data according to an embodiment of the present disclosure.

FIG. 5 is a diagram for describing an example of an operation of managing, by a controller included in a storage device, an internal memory space according to an embodiment of the present disclosure.

### DETAILED DESCRIPTION

Various embodiments of the present disclosure are described below with reference to the accompanying drawings. Elements and features of the disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language includes hardware-for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in the disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

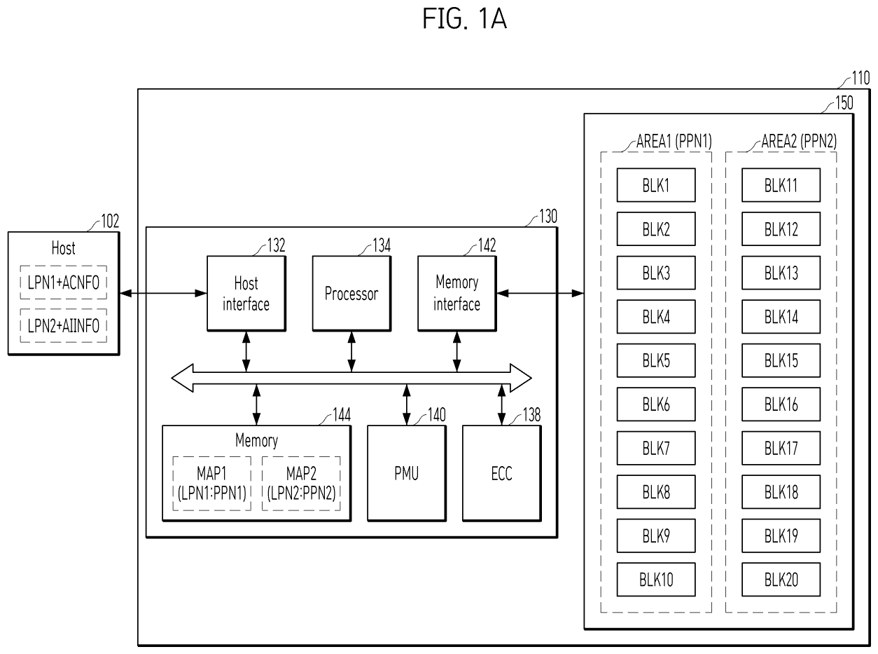

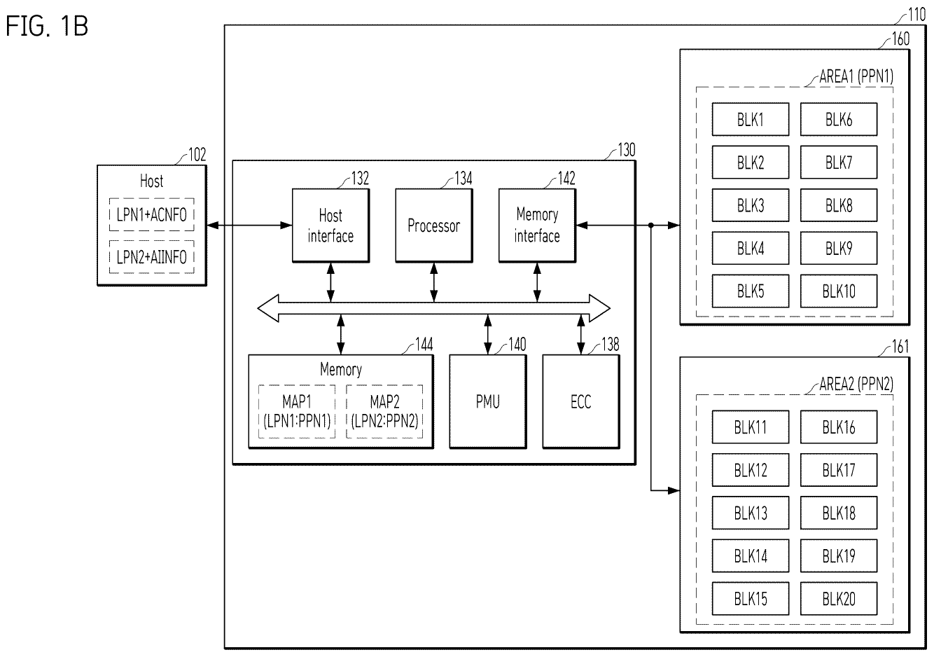

FIGS. 1A and 1B are diagrams for describing an example and another example of a data processing system including a storage device according to embodiments of the present disclosure.

Referring to FIGS. 1A and 1B, a data processing system 100 may include a host 102 engaged or coupled with a storage device, such as storage device 110. For example, the host 102 and the storage device 110 can be coupled to each other via a data bus, a host cable and the like to perform data communication.

The storage device 110 may include a memory device 150 (160, 161 in FIG. 1B) and a controller 130.

According to an embodiment, the memory device 150 (160, 161 in FIG. 1B) and the controller 130 may be components or functionally divided elements. Further, according to an embodiment, the memory device 150 (160, 161 in FIG. 1B) and the controller 130 may be implemented with a single chip or a plurality of chips. The controller 130 may perform a data input/output operation in response to a request input from the external device. For example, when the controller 130 performs a read operation in response to a read request input from an external device, data stored in a plurality of non-volatile memory cells included in the memory device 150 (160, 161 in FIG. 1B) is transferred to the controller 130.

In an embodiment, the memory device 150 (160, 161 in FIG. 1B) may be a non-volatile memory.

The nonvolatile memory device is a memory device in which data stored therein is retained even when power supply is interrupted. Representative examples of a nonvolatile memory device include a read only memory (ROM), a programmable ROM (PROM), an electrically programmable ROM (EPROM), an electrically erasable programmable ROM (EEPROM), a flash memory, a phase-change random access memory (PRAM), a magnetic RAM (MRAM), a resistive RAM (RRAM), a ferroelectric RAM (FRAM), etc.

The controller 130 may control the memory device 150 (160, 161 in FIG. 1B) to perform read, program and erase operations corresponding to commands inputted from the host 102. The controller 130 may control the memory device 150 (160, 161 in FIG. 1B) to independently perform operations using the storage device 110 regardless of commands inputted from an external device such as the host 102.

The memory device 150 (160, 161 in FIG. 1B) and the controller 130 in the storage device 110 may be components or elements that are physically separated from each other. The memory device 150 (160, 161 in FIG. 1B) and the controller 130 may be connected via at least one data path. For example, the data path may include a channel and/or a way.

Specifically, the memory device 150 (160, 161 in FIG. 1B) may include a first storage area AREA1 and a second storage area AREA2. That is, the controller 130 may separately control some storage spaces, among a plurality of storage spaces included in the memory device 150 (160, 161 in FIG. 1B), as the first storage area AREA1, and may separately control the remaining storage spaces as the second storage area AREA2. Furthermore, the controller 130 may manage a plurality of storage spaces included in the first storage area AREA1 and a plurality of storage spaces included in the second storage area AREA2 independently and separately so that the plurality of storage spaces included in the first storage area AREA1 and the plurality of storage spaces included in the second storage area AREA2 are distinct from each other in terms of operational access. For example, when performing an operation of substituting a bad storage space, among the plurality of storage spaces included in the first storage area AREA1, the controller 130 may select a required storage space only in the plurality of storage spaces included in the first storage area AREA1.

According to an embodiment, the memory device 150 (160, 161 in FIG. 1B) may include a plurality of memory blocks BLK<1:20>, and some memory blocks BLK<1:10> may be in the first storage area AREA1, and the remaining memory blocks BLK<11:20> may be in the second storage area AREA2. That is, the controller 130 may separately control some memory blocks BLK<1:10>, among the plurality of memory blocks BLK<1:20> included in the memory device 150 (160, 161 in FIG. 1B), as the first storage area AREA1, and may separately control the remaining memory blocks BLK<11:20>as the second storage area AREA2.

Furthermore, the some memory blocks BLK<1:10> included in the first storage area AREA1 may correspond to a first physical address PPN1. The remaining memory blocks BLK<11:20> included in the second storage area AREA2 may correspond to a second physical address PPN2. That is, the controller 130 may access data in the some memory blocks BLK<1:10> included in the first storage area AREA1 by adjusting the value of the first physical address PPN1. Furthermore, the controller 130 may access data in the remaining memory blocks BLK<11:20> included in the second storage area AREA2 by adjusting the value of the second physical address PPN2. When the controller 130 performs an “access data” operation, the accessed target data are stored (written/programmed) through a program or write operation, or are previously stored data and read through a read operation.

For reference, in FIGS. 1A and 1B, it is assumed that, of the total of twenty memory blocks BLK<1:20> included in the memory device 150 (160, 161 in FIG. 1B), ten memory blocks BLK<1:10> of the total of twenty memory blocks BLK<1:20> are assigned to the first storage area AREA1, and the remaining ten memory blocks BLK<11:20> are assigned to the second storage area AREA2. However, this is merely an assumption for convenience of description. The memory blocks can be divided so that more or less than ten memory blocks are included in each of the first storage area AREA1 and the second storage area AREA2. Also, the number of memory blocks included in each of the first storage area AREA1 and the second storage area AREA2 may be different.

For example, as illustrated in FIG. 1A, all of the twenty memory blocks BLK<1:20> may be physically included in one memory device 150. The twenty memory blocks BLK<1:20> may be divided into ten memory blocks BLK<1:10> as the first storage area AREA1 and the remaining ten memory blocks BLK<11:20> as the second storage area AREA2.

As another example, as illustrated in FIG. 1B, ten memory blocks BLK<1:10/11:20> may be included in each of the memory devices 160 and 161, which are physically divided. The ten memory blocks BLK<1:10> included in memory device 160 may be assigned as the first storage area AREA1, and ten memory blocks BLK<11:20> included in memory device 161 may be assigned as the second storage area AREA2.

Furthermore, in the example in FIG. 1B, only the two memory devices 160 and 161 that are physically divided are included in the storage device 110, but this is merely an embodiment. More than two memory devices may be included in the storage device 110. Among the memory blocks, at least one memory device may be designated as the first storage area AREA1, and the remaining one or more memory devices may be designated as the second storage area AREA2.

Furthermore, FIGS. 1A and 1B illustrate examples in which a plurality of memory blocks BLK<1:20> is included in the memory device 150 (160, 161 in FIG. 1B), but this is merely an embodiment. In other embodiments, at least one plane (not illustrated) including at least two memory blocks may be included in the memory device 150 (160, 161 in FIG. 1B), or at least one memory die (not illustrated) including at least one plane may be included in the memory device 150 (160, 161 in FIG. 1B). Furthermore, although not illustrated in FIGS. 1A and 1B, each of the plurality of memory blocks BLK<1:20> included in the memory device 150 (160, 161 in FIG. 1B) may include a plurality of pages (not illustrated).

The memory blocks may be understood as a group of non-volatile memory cells from which data are removed together through an erase operation. Each of the memory blocks may include a page (not illustrated) in which the non-volatile memory cells are grouped, from a logical point of view, to facilitate storing of data together during the program operation or outputting of data together during the read operation. For example, one memory block may include a plurality of pages. One page may include a plurality of non-volatile memory cells.

From a physical point of view, and not from the logical point of view in a program operation or in a read operation, one memory block may include a plurality of word lines (not illustrated). One word line may include a plurality of non-volatile memory cells.

For example, one word line may correspond to at least one page according to the number of bits that can be stored or expressed in one non-volatile memory cell. For example, when one non-volatile memory cell is a single level cell (SLC) storing one data bit, one word line may correspond to one page. When one non-volatile memory cell is a double level cell (DLC) storing two data bits, one word line may correspond to two pages. When one non-volatile memory cell is a triple level cell (TLC) storing three data bits, one word line may correspond to three pages. When one non-volatile memory cell is a quadruple level cell (QLC) storing four data bits, one word line may correspond to four pages. Similarly, when one non-volatile memory cell is a multiple level cell storing five or more data bits, one word line may correspond to five or more pages.

As described below, the storage device 110 according to an embodiment of the present disclosure may an access operation on the first storage area AREA1 included in the memory device 150 (160, 161 in FIG. 1B) and separately perform an access operation on the second storage area AREA2 included in the memory device 150 (160, 161 in FIG. 1B).

Data that are accessed in the first storage area AREA1 are “first data” and data that are accessed in the second storage area AREA2 are “second data”. In this example, the controller 130 may determine whether data, that is, an access target, are included in the “first data” or the “second data” based on the value of an access logical address that is input along with an access command from the host 102.

For example, when the value of an access logical address that is input from the host 102 is included in a first logical address LPN1, the controller 130 may identify that data, that is, an access target, are data included in the “first data”, and may perform an access operation on the first storage area AREA1.

As another example, when the value of an access logical address that is input from the host 102 is included in the second logical address LPN2, the controller 130 may identify that data, that is, an access target, are data included in the “second data”, and may perform an access operation on the second storage area AREA2.

Furthermore, when access to the first storage area AREA1 is requested by the host 102, that is, when an access request including an access logical address is included in the first logical address LPN1 from the host 102, the controller 130 may identify that data to which the access has been requested as the “first data”. Furthermore, the controller 130 may divide the first data corresponding to the first logical address LPN1 by a preset size unit, and may access the first data in the first storage area AREA1.

For example, assuming that a preset size is 4 KB, which is the size of one page, the controller 130 may access the space of the first storage area AREA1 by units of a page by dividing the first data by the size of 4 KB.

Furthermore, the controller 130 may manage first map information MAP1 that accesses the first storage area AREA1 by dividing the first data by a preset size unit. That is, the value of the first logical address LPN1 that is input from the host 102 may be changed on the basis of a preset size. Accordingly, the controller 130 may divide the first data by a preset size unit, and may map the first data to a first physical address PPN1 corresponding to the first storage area AREA1. The controller 130 may manage information in relation to a mapping relation between the first logical address LPN1 and the first physical address PPN1 as the first map information MAP1. That is, the controller 130 may manage one piece of first map information by mapping one first logical address to one first physical address.

Assuming that the preset size is 4 KB, that is, the size of one page, the value of each of the first logical addresses LPN1 that are input from the host 102 may be a value corresponding to data having the size of 4 KB. For example, when a first data is 8KB in size, the host 102 may set the values for two first logical addresses LPN1 as corresponding to 4KB each. Furthermore, the controller 130 may divide the space of the first storage area AREA1 by a page unit of 4 KB. The controller 130 may assign two pages from first storage area AREA1 to store any 8 KB-sized first data for which an access request has been made by the host 102. Accordingly, the controller 130 may manage, as in first map information MAP1, two first logical addresses set in the host 102 and two first physical addresses corresponding to two pages that are assigned to the first storage area AREA1 and that correspond to the size of 8 KB. This first map information MAP1 is managed by mapping the two first logical addresses to the two first physical addresses in accordance with any first data having a size of 8 KB.

Furthermore, when access to the second storage area AREA2 is requested by the host 102, that is, when an access request including an access logical address included in the second logical address LPN2 is input from the host 102, the controller 130 may identify that data to which the access has been requested as “second data”. Furthermore, when access to N second data (i.e., an N number of second data) is requested by the host 102, the controller 130 may access the second storage area AREA2 by referencing the size of each of the N second data. Furthermore, in order to access the second storage area AREA2, the controller 130 may manage N pieces of second map information MAP2. Each piece of second map information MAP2 includes mapping information for one of the N second data. In this case, N may be a natural number equal to or greater than 1.

According to an embodiment, access to the N second data may be requested in accordance with N second logical addresses LPN2 from the host 102. In this case, when the N second data correspond to N second logical addresses LPN2, this may mean that one second logical address corresponds to one of the N second data.

Furthermore, in some cases, one of the N second data may have a size greater than the size of at least two pages, where a plurality of storage spaces that have the same size as a page unit is included in the second storage area AREA2.

In such cases, the controller 130 may assign at least two storage spaces, among the plurality of storage spaces included in the second storage area AREA2, to store the one of the N second data to which access has been requested by the host 102. That is, the controller 130 may manage one second logical address and at least two second physical addresses as one piece of the second map information, that is, the controller 130 may map the one second logical address and the at least two second physical addresses as a single piece pf second map information MAP2. Furthermore, the controller 130 may select two or more sequential or contiguous storage spaces to store the one of the N second data, among the plurality of storage spaces included in the second storage area AREA2, so that the two or more storage spaces have a sequential relation with respect to physical addresses. That is, the two or more storage spaces assigned to store one of the N second data, among the plurality of storage spaces included in the second storage area AREA2, may be spaces that are set to be continuously accessed through an interleaving method by the controller 130.

Any one of the N second data may be referred to as selection data when targeted by an access command. Referring to FIG. 1A, when the access command that accesses selection data, that is, any one of the N second data, is input from the host 102, the controller 130 may identify access information AIINFO included in the input access command, and may sequentially select at least two selection spaces, in a preset order, in which the selection data will be accessed, from among the plurality of storage spaces included in the second storage area AREA2.

According to an embodiment, the controller 130 may sequentially write selection data in at least two selection spaces selected in the second storage area AREA2 in response to a first write command that is input from the host 102. The controller 130 may generate selection map information by mapping at least two physical addresses corresponding to the at least two selection spaces selected in the second storage area AREA2 to one logical address corresponding to the selection data. The controller 130 may map selection data to one of N pieces of second map information MAP2.

Furthermore, the controller 130 may update at least a part of selection data with a substitution value in response to a second write command that is input from the host 102.

According to an embodiment, from among the storage spaces in the second storage area AREA2, the controller 130 may select a substitution space to be used with a substitution value that updates the selection data, with reference to the access information AIINFO and selection map information that are included in a second write command.

Furthermore, the controller 130 may select a target space in a free state, among the plurality of storage spaces included in the second storage area AREA2, for use in the substitution operation. For example, the controller 130 may select, as a target space, storage spaces in a free state in second storage area AREA2 that may be sequentially accessed in a preset order. The controller 130 may select the same number of free state target spaces as the number of the at least two selection spaces storing the selection data.

Thus, the substitution values may be stored in the substitution spaces, where the substitution values will replace a portion of the selection data stored in the at least two selection spaces. Since the target spaces are the same size as the at least two selection spaces, the controller 130 may store the substitution values that replace some of the selection data in the target spaces and store the remainder of the selection data (i.e., the unsubstituted data) in the target spaces. Then, the controller 130 may update selection map information by mapping one logical address corresponding to the selection data to the logical address of the target space.

In the above description, N is indicative of the number of second data may be a natural number equal to or greater than 1. Furthermore, hereinafter, it is assumed that N is 2.

For example, storage of the 1^{st} second data having a size of 64 KB based on a 1^{st} second logical address that is input along with the 1^{st} first write command may be requested by the host 102. The controller 130 may identify that a size corresponding to the 1^{st} second data is 64 KB by identifying the access information AIINFO included in the 1^{st} first write command, and may select sixteen storage spaces (assuming storage spaces are in units of 4 KB unit) with a total size of 64 KB, from among the plurality of storage spaces included in the second storage area AREA2 and use the selected spaces to store the 1^{st} second data. Furthermore, the controller 130 may sequentially write the 1^{st} second data having the size of 64 KB in sixteen storage spaces selected in the second storage area AREA2, and the address sequence determines a preset order. The controller 130 may generate one piece of the second map information by mapping one second logical address corresponding to the 1^{st} second data and the sixteen physical addresses corresponding to the sixteen storage spaces. As described above, the controller 130 may sequentially read the 1^{st} second data in preset order from the second storage area AREA2 because the controller 130 has previously sequentially written the 1^{st} second data in the second storage area AREA2 to set the preset order.

When substitution data having a size of 16 KB is input from the host 102 along with the 1^{st} second write command, the host 102 may request the update of data corresponding to the size of 16 KB from among the 1^{st} second data having the size of 64 KB. In this instance, the controller 130 may select four substitution spaces, that total 16 KB in size, to store the substitution data to be used in the update. The substitution data and the 1^{st} second data are used in the substitution operation in the second storage area AREA2 with reference to the access information AIINFO included in the 1^{st} second write command and one piece of the second map information corresponding to the 1^{st} second data.

In the substitution operation, the controller 130 may select sixteen target spaces that are in a free state in the second storage area AREA2. The sixteen target spaces may be sequentially accessed in address order.

The controller 130 may store, in the sixteen target spaces, both the substitution data from the substitution spaces having the size of 16 KB and the remaining 48KB 1^{st} second data that are not substituted and stored in ten of the sixteen selection data spaces. Then, the controller 130 may map one second logical address corresponding to the 1^{st} second data to sixteen physical addresses corresponding to the sixteen target spaces in the second storage area AREA2. Accordingly, the update of 16 KB of 1^{st} second data with 16 KB of substitution data may be completed.

For example, storage of the 2^{nd} second data having a size of 128 KB based on a 1^{st} second logical address that is input along with the 2^{nd} first write command may be requested by the host 102. The controller 130 may identify that a size corresponding to the 2^{nd} second data is 128 KB by identifying the access information AIINFO included in the 2^{nd} first write command, and may select thirty-two spaces (assuming storage spaces are in units of 4 KB unit) with a total size of 128 KB, from among the plurality of storage spaces included in the second storage area AREA2 and use the selected spaces to store the 2^{nd} second data. Furthermore, the controller 130 may sequentially write the 2^{nd} second data having the size of 128 KB in the thirty-two spaces selected in the second storage area AREA2, and the address sequence determines a preset order. The controller 130 may generate one piece of the second map information by mapping one second logical address corresponding to the 2^{nd} second data and the thirty-two physical addresses corresponding to thirty-two storage spaces selected in the second storage area AREA2. As described above, the controller 130 may sequentially read the 2^{nd} second data in preset order from the second storage area AREA2 because the controller 130 has previously sequentially written the 2^{nd} second data in the second storage area AREA2 to set the preset order.

When, substitution data having a size of 48 KB is input from the host 102 along with the 2^{nd} second write command, the host 102 may request the update of data having the size of 48 KB from among the 2^{nd} second data having the size of 128 KB. Therefore, the controller 130 may select twelve substitution spaces, that total 48 KB in size, to store the substitution data to be used in the update. The substitution data and the 2^{nd} second data are used in the substitution operation in the second storage area AREA2 with reference to the access information AIINFO included in the 2^{nd} second write command and one piece of the second map information corresponding to the 2^{nd} second data.

In the substitution operation, the controller 130 may select the thirty-two target spaces that are in a free state in the second storage area AREA2. The thirty-two target spaces may be sequentially accessed in address order.

The controller 130 may store, in the thirty-two target spaces, both the substitution data from the substitution spaces having the size of 48 KB and the remaining 80 KB of 2^{nd} second data that are not substituted and stored in twenty of the thirty-two selection data spaces. Then, the controller 130 may map one second logical address corresponding to the 2^{nd} second data to the thirty-two physical addresses corresponding to the thirty-two target spaces in the second storage area AREA2. Accordingly, the update of 48 KB of data, among the 128 KB of 2^{nd} second data, can be completed.

As described above, the size of second data may be previously defined in the corresponding access information AIINFO that is input along with the access command from the host 102. That is, when generating the second data, the host 102 may previously generate the access information AIINFO corresponding to each of the second data.

In the above description, the operating of dividing, by the controller 130, the first data by a preset size unit and accessing the first storage area AREA1 is substantially the same as an operation of reading/programming (writing) data in a page unit by a flash memory device. Accordingly, in embodiments of the present disclosure, the first data may refer to “normal data” that are subject to normal read/program (write) operations in a nonvolatile memory device, such as a flash memory device. Accordingly, the first data that are divided into the preset size units may be stored in the first storage area AREA1 without measures that would allow subsequent sequential access to the first data.

Furthermore, in the above description, the second data may be stored in the second storage area AREA2 in a state in which sequential access to the second data can been guaranteed when the second data are stored. In particular, even if the second data is large in size, sequential access to the second data in a nonvolatile memory device can be guaranteed. Furthermore, as described in the Background of the present disclosure, an operation of sequentially processing data having a very large size is required in technical areas, such as in AI applications and in big data analysis. Accordingly, the second data exemplified in an embodiment of the present disclosure may refer to “AI data” that are used in such technical areas.

Referring to FIGS. 1A and 1B, the controller 130 may include a host interface 132, a processor 134, error correction circuitry (ECC) 138, a power management unit (PMU) 140, a memory interface 142, and a memory 144. Components included in the controller 130 as illustrated in FIGS. 1A and 1B may vary according to structures, functions, operation performance, or the like, of the storage device 110.

The host 102 and the storage device 110 each may include a controller or an interface for transmitting and receiving signals, data, and the like, in accordance with one or more predetermined protocols. For example, the host interface 132 in the storage device 110 may include an apparatus capable of transmitting signals, data, and the like to the host 102 or receiving signals, data, and the like from the host 102.

The host interface 132 included in the controller 130 may receive signals, commands (or requests), and/or data input from the host 102 via a bus. For example, the host 102 and the storage device 110 may use a predetermined set of rules or procedures for data communication or a preset interface to transmit and receive data therebetween.

Examples of communication standards or interfaces used to transmit/receive data may include various form factors such as 2.5-inch form factor, 1.8-inch form factor, MO-297, MO-300, M.2, and EDSFF (Enterprise and Data Center SSD Form Factor) and various communication standards or interfaces such as USB (Universal Serial Bus), MMC (Multi-Media Card), PATA (Parallel Advanced Technology Attachment), SCSI (Small Computer System Interface), ESDI (Enhanced Small Disk Interface), IDE (Integrated Drive Electronics), PCIe (Peripheral Component Interconnect Express), SAS (Serial-attached SCSI), SATA (Serial Advanced Technology Attachment), and MIPI (Mobile Industry Processor Interface).

According to an embodiment, the host interface 132 is a type of layer for exchanging data with the host 102 and is implemented with, or driven by, firmware called a host interface layer (HIL). According to an embodiment, the host interface 132 can include a command queue.

The Integrated Drive Electronics (IDE) or Advanced Technology Attachment (ATA) may be used as one of the interfaces for transmitting and receiving data and, for example, may use a cable (not illustrated) including 40 wires connected in parallel to support data transmission and data reception between the host 102 and the storage device 110. When a plurality of storage devices 110 are connected to a single host 102, the plurality of storage devices 110 may be divided into a master and a slave by using a position or a dip switch to which the plurality of storage devices 110 are connected. The storage device 110 set as the master may be used as a main memory device. The IDE (ATA) may include, for example, Fast-ATA, ATAPI, or Enhanced IDE (EIDE).

A Serial Advanced Technology Attachment (SATA) interface is a type of serial data communication interface that is compatible with various ATA standards of parallel data communication interfaces that are used by Integrated Drive Electronics (IDE) devices. The 40 wires in the IDE interface can be reduced to six wires in the SATA interface. For example, 40 parallel signals for the IDE can be converted into 6 serial signals for the SATA interface. The SATA interface has been widely used because of its faster data transmission and reception rate and its lower resource consumption in the host 102. The SATA interface may connect up to 30 external devices to a single transceiver included in the host 102. In addition, the SATA interface can support hot plugging that allows an external device to be attached to or detached from the host 102, even while data communication between the host 102 and another device is being executed. Thus, the storage device 110 can be connected or disconnected as an additional device, like a device supported by a universal serial bus (USB) even when the host 102 is powered on. For example, in the host 102 having an eSATA port, the storage device 110 may be freely attached to or detached from the host 102 like an external hard disk.

Small Computer System Interface (SCSI) is a type of serial data communication interface used for connecting a computer or a server with other peripheral devices. The SCSI can provide a high transmission speed, as compared with other interfaces such as IDE and SATA. In the SCSI, the host 102 and at least one peripheral device (e.g., storage device 110) are connected in series, but data transmission and reception between the host 102 and each peripheral device may be performed through a parallel data communication. In the SCSI, it is easy to connect or disconnect a device such as the storage device 110 to or from the host 102. The SCSI can support connections of 15 other devices to a single transceiver included in host 102.

Serial Attached SCSI (SAS) can be understood as a serial data communication version of the SCSI. In the SAS, the host 102 and a plurality of peripheral devices are connected in series, and data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-volatile memory express (NVMe) is a type of interface based at least on a Peripheral Component Interconnect Express (PCIe) designed to increase performance and design flexibility of the host 102, servers, computing devices, and the like equipped with a non-volatile storage device 110. The PCIe can use a slot or a specific cable for connecting a computing device (e.g., host 102) and a peripheral device (e.g., storage device 110). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second (e.g., 250 MB/s, 500 MB/s, 984.6250 MB/s, or 1969 MB/s). According to an embodiment, the PCIe scheme may achieve bandwidths of tens to hundreds of Giga bits per second. The NVMe can support an operation speed of a non-volatile storage device 110, such as an SSD, that is faster than a hard disk.

According to an embodiment, a host 102 and a storage device 110 may be connected through a universal serial bus (USB). The Universal Serial Bus (USB) is a type of scalable, hot-pluggable plug-and-play serial interface that can provide cost-effective standard connectivity between the host 102 and peripheral devices such as a keyboard, a mouse, a joystick, a printer, a scanner, a storage device, a modem, a video camera, and the like. A plurality of peripheral devices such as a plurality of storage devices 110 may be coupled to a single transceiver included in the host 102.

The power management unit (PMU) 140 may control electrical power provided to the controller 130. The PMU 140 may monitor the electrical power supplied to the storage device 110, e.g., a voltage supplied to the controller 130, and provide electrical power to components included in the controller 130. The PMU 140 may not only detect power-on or power-off, but also generate a trigger signal to enable the storage device 110 to urgently back up a current state when the electrical power supplied to the storage device 110 is unstable. According to an embodiment, the PMU 140 may include a device or a component capable of accumulating electrical power that may be used as a reserve or under critical circumstances.

The memory interface 142 may serve as an interface for handling commands and data transferred between the controller 130 and a memory device (150 in FIGS. 1A and 160, 161 in FIG. 1B), in order to allow the controller 130 to control the memory device in response to a command or a request input from the host 102. The memory interface 142 may generate a control signal for the memory device and may process data input to, or output from, the memory device under the control of the processor 134 in a case when the memory device is a flash memory.

For example, when a memory device (150 in FIGS. 1A and 160, 161 in FIG. 1B) includes a NAND flash memory, the memory interface 142 includes a NAND flash controller (NFC). The memory interface 142 can provide an interface for handling commands and data between the controller 130 and the memory device. In accordance with an embodiment, the memory interface 142 can be implemented through, or driven by, firmware called a Flash Interface Layer (FIL) for exchanging data with the memory device.

According to an embodiment, the memory interface 142 may support an open NAND flash interface (ONFi), a toggle mode, or the like, for data input/output with a memory device (150 in FIGS. 1A and 160, 161 in FIG. 1B). For example, the ONFi may use a data path (e.g., a channel, a way, etc.) that includes at least one signal line capable of supporting bi-directional transmission and reception in a unit of 8-bit or 16-bit data. Data communication between the controller 130 and the memory device can be achieved through at least one interface regarding an asynchronous single data rate (SDR), a synchronous double data rate (DDR), a toggle double data rate (DDR), or the like.

The memory 144 may be used as a working memory of the storage device 110 or the controller 130, while temporarily storing transactional data for operations performed in the storage device 110 and the controller 130. For example, in response to a read request from the host 102, the memory 144 may temporarily store read data entries output from a memory device (150 in FIGS. 1A and 160, 161 in FIG. 1B) before the read data entries are output to the host 102. In addition, the controller 130 may temporarily store write data entries input from the host 102 in the memory 144 before programming the write data entries into the memory device. When the controller 130 controls operations, such as a data read operation, a data write or program operation, a data erase operation, etc., of the memory device, data transmitted between the controller 130 and the memory device 150 of the storage device 110 may be temporarily stored in the memory 144.

According to an embodiment, the memory 144 may include program memory, data memory, a write buffer/cache, a read buffer/cache, a data buffer/cache, and a map buffer/cache. In particular, the memory 144 according to an embodiment of the present disclosure may store first map information MAP1 and second map information MAP2.

In an embodiment, the memory 144 may be implemented with a volatile memory. For example, the memory 144 may be implemented with a static random access memory (SRAM), a dynamic random access memory (DRAM), or both. Although FIG. 1 illustrates, for example, the memory 144 disposed within the controller 130, embodiments are not limited thereto. The memory 144 may be located within or external to the controller 130. For instance, the memory 144 may be implemented as an external volatile memory having a memory interface transferring data and/or signals between the memory 144 and the controller 130.

In addition to read data entries or write data entries, the memory 144 may store information, e.g., map data, read requests, program requests, etc. used for inputting or outputting data between the host 102 and a memory device (150 in FIGS. 1A and 160, 161 in FIG. 1B). According to an embodiment, the memory 144 may include one or more of a command queue, a program memory, a data memory, a write buffer/cache, a read buffer/cache, a data buffer/cache, a map buffer/cache, and so on. The controller 130 may allocate some storage space in the memory 144 for a component that is used to carry out a data input/output operation. For example, the write buffer in the memory 144 may be used to temporarily store target data subject to a program operation.

The error correction circuitry 138 may check and correct errors in data transmitted between the controller 130 and a memory device (150 in FIGS. 1A and 160, 161 in FIG. 1B). The error correction circuitry 138 may be implemented as a separate module, circuit or firmware in the controller 130, but also be implemented in the memory device according to an embodiment.

The error correction circuitry 138 may include all circuits, modules, systems, and/or devices for performing error correction operations.

The error correction circuitry 138 can correct error bits of data read from a memory device (150 in FIGS. 1A and 160, 161 in FIG. 1B), and may include an error correction code (ECC) encoder and an ECC decoder. The ECC encoder may perform error correction encoding of data to be programmed in the memory device to generate encoded data into which a parity bit is added, and store the encoded data in the memory device. The ECC decoder can detect and correct error bits contained in the data read from the memory device 150 when the controller 130 reads the data stored in the memory device 150. For example, after performing error correction decoding on the data read from the memory device, the error correction circuitry 138 determines whether the error correction decoding has succeeded or not, and outputs an instruction signal, e.g., a correction success signal or a correction fail signal, based on a result of the error correction decoding. The error correction circuitry 138 may use a parity bit, which has been generated during the ECC encoding process for the data stored in the memory device, in order to correct the error bits of the read data entries. When the number of the error bits is greater than or equal to the number of correctable error bits, the error correction circuitry 138 may not correct the error bits and instead may output a correction fail signal indicating failure in correcting the error bits.

According to an embodiment, the error correction circuitry 138 may perform error correction operations based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like.

An operation performed by the ECC decoder, that is, an operation of detecting and correcting errors included in read data, may be an operation distinct from a read retry operation. According to an embodiment, the controller 130 may perform an error correction decoding operation through the ECC decoder when errors equal to or greater than a reference value occur even though a read retry operation, which is a repeated read operation, has been performed using a plurality of read retry levels.

The processor 134 may control the overall operations of the storage device 110. For example, the processor 134 can control a program operation or a read operation of a memory device (150 in FIGS. 1A and 160, 161 in FIG. 1B) in response to a write request or a read request entered from the host 102.

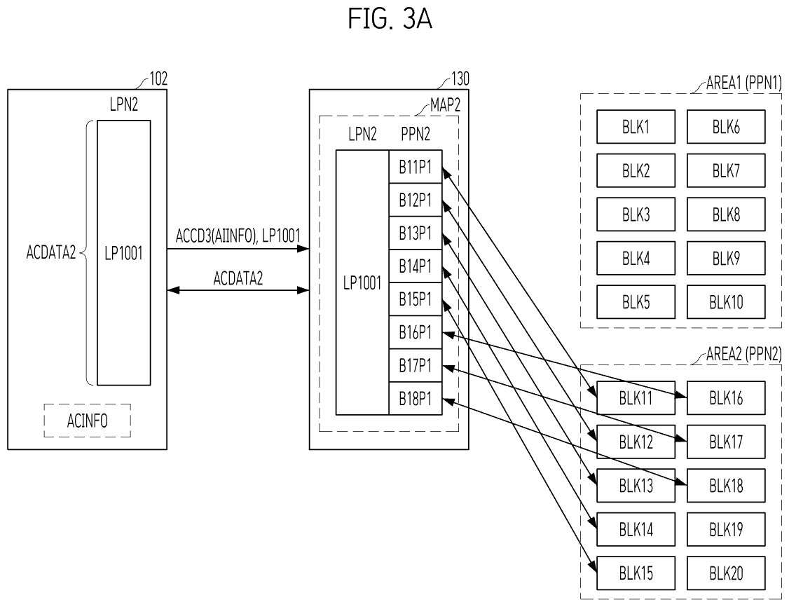

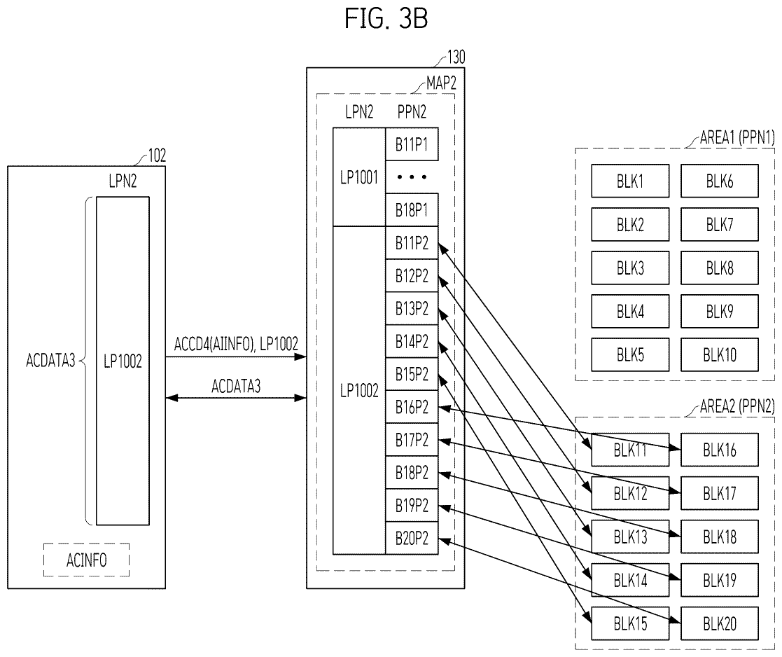

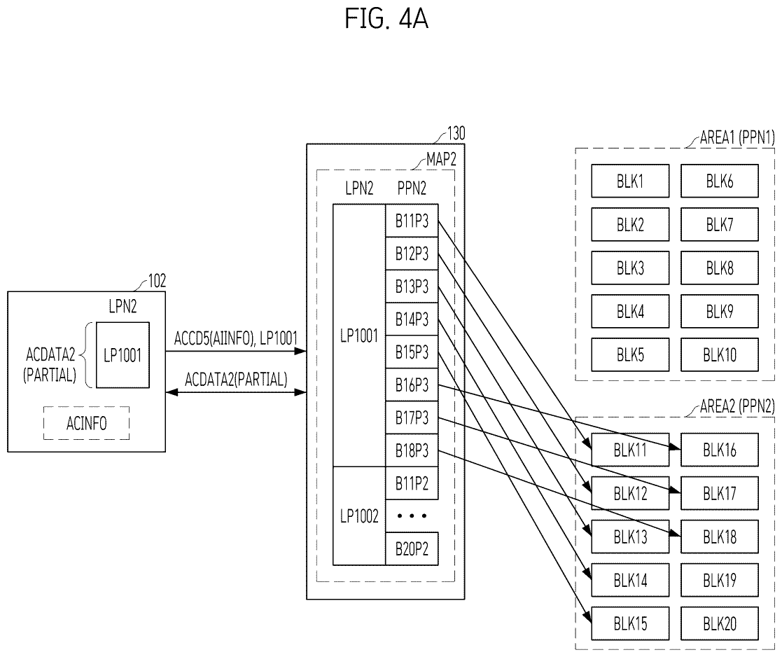

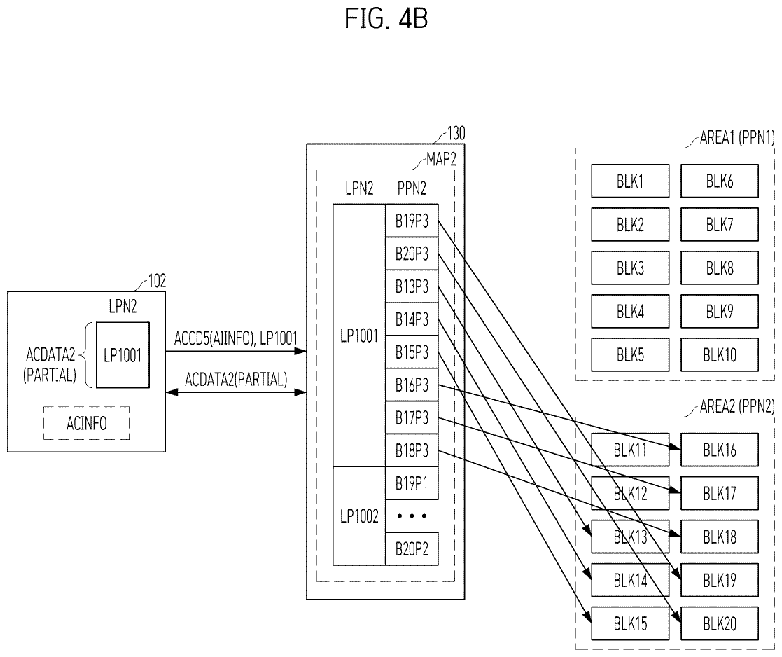

According to an embodiment, the processor 134 may execute firmware to control the program operation or the read operation in the storage device 110. Herein, the firmware may be referred to as a flash translation layer (FTL). An example of the FTL will be described in detail, referring to FIGS. 3 and 4. According to an embodiment, the processor 134 may be implemented with a microprocessor, a central processing unit (CPU), or the like.

According to an embodiment, the storage device 110 may be implemented with at least one multi-core processor. A multi-core processor is a type of circuit or chip in which two or more cores, which are considered distinct processing regions, are integrated. For example, when a plurality of cores in the multi-core processor drive or execute a plurality of flash translation layers (FTLs) independently, a data input/output speed (or performance) of the storage device 110 may be improved. According to an embodiment, the data input/output (I/O) operations in the storage device 110 may be independently performed through different cores in the multi-core processor.

The processor 134 controls the entire operations of the storage device 110. In particular, the processor 134 controls a program operation or a read operation for a memory device (150 in FIGS. 1A and 160, 161 in FIG. 1B) in response to a write request or a read request from the host 102. The processor 134 drives firmware, which is referred to as a flash translation layer (FTL), to control general operations of the storage device 110. The processor 134 may be realized by a microprocessor or a central processing unit (CPU).

For instance, the controller 130 performs an operation requested from the host 102, in a memory device (150 in FIGS. 1A and 160, 161 in FIG. 1B). That is, the controller 130 performs a command operation corresponding to a command received from the host 102, with the memory device, through the processor 134 embodied by a microprocessor or a central processing unit (CPU). The controller 130 may perform a foreground operation as a command operation corresponding to a command received from the host 102. For example, the controller 130 may perform a program operation corresponding to a write command, a read operation corresponding to a read command, an erase operation corresponding to an erase command, a parameter set operation corresponding to a set command or set parameter command or set feature command.

The controller 130 may also perform a background operation for a memory device (150 in FIGS. 1A and 160, 161 in FIG. 1B), through the processor 134 embodied by a microprocessor or a central processing unit (CPU). The background operation for the memory device may include an operation of copying data stored in a memory block among the memory blocks 152, 154 and 156 (not illustrated) of the memory device to another memory block, for example, a garbage collection (GC) operation. The background operation may include an operation of swapping data between one or more of the memory blocks 152, 154 and 156 of the memory device, for example, a wear leveling (WL) operation, a read reclaim (RR) operation and media scan operation. The background operation may include an operation of storing map data retrieved from the controller 130 in the memory blocks 152, 154 and 156 of the memory device, for example, a map flush operation. The background operation may include a bad management operation for the memory device, which may include checking for and processing a bad block among the plurality of memory blocks 152, 154 and 156 in the memory device.

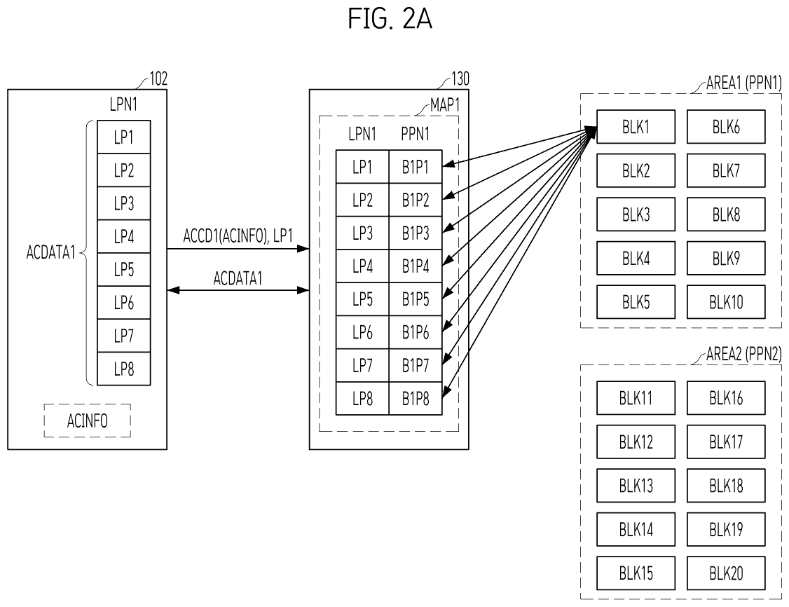

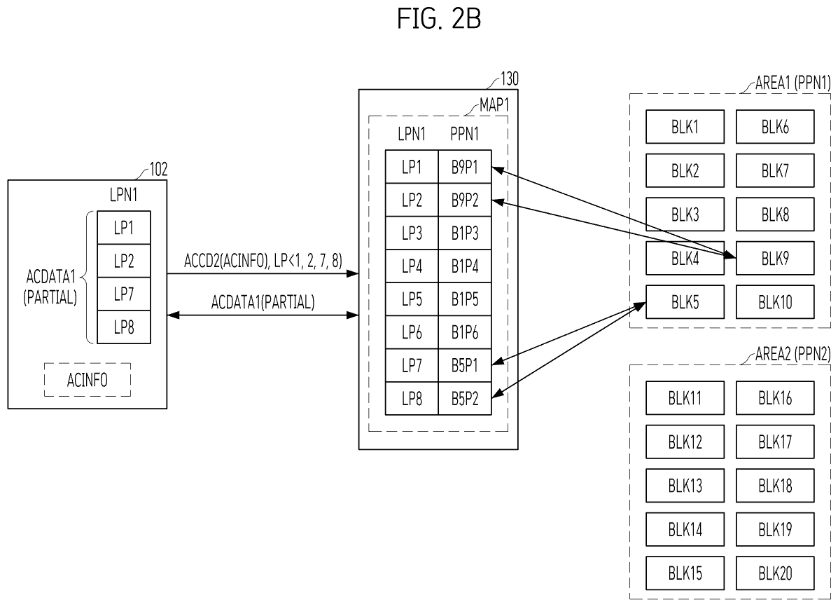

FIGS. 2A and 2B are diagrams for describing examples of operations of accessing, by the storage device, normal data according to an embodiment of the present disclosure.

FIG. 2A illustrates an example of an operation of accessing normal data that are generated by a host 102 in a first storage area AREA1 according to an embodiment of the present disclosure.

The host 102 may generate first access data ACDATA1 and may divide the first access data ACDATA1 in a preset size unit because the host 102 determines that the first access data ACDATA1 are normal data, and therefore subsequent access to the first access data ACDATA1 does not require sequential data storage in the storage area. The host 102 may divided the first access data ACDATA1 in a size unit that corresponds to a plurality of access logical addresses LP<1:8>.

For example, as illustrated in FIG. 2A, it may be assumed that the first access data ACDATA1 are divided into eight data groups when the first access data ACDATA1 are divided in a preset size unit corresponding to the size of one page. Accordingly, the host 102 may map the first access data ACDATA1 to the eight access logical addresses LP<1:8>.

Furthermore, the host 102 may include state information ACINFO, indicating the state of the first access data ACDATA1 , that is, normal data, at the eight access logical addresses LP<1:8>, in an access command ACCD1, which corresponds to the first access data ACDATA1.

Furthermore, along with the access command ACCD1 corresponding to a write operation, the host 102 may output the start address LP1, among the eight access logical addresses LP<1:8>, and the first access data ACDATA1, to the controller 130 included in the storage device 110.

The controller 130 does not search first map information MAP1 for the value of the start address LP1 input along with the access command ACCD1 corresponding to a write operation when the controller 130 determines that the first access data ACDATA1 are normal data. This is determined by controller 130 when it identifies that the start address LP1 is included in a first logical address LPN1. Furthermore, the controller 130 may assign eight storage spaces, among the plurality of storage spaces included in the first storage area AREA1, by identifying the state information ACINFO included in the access command ACCD1 in order to store the first access data ACDATA1.

Accordingly, the controller 130 may select eight pages, among a plurality of pages included in the first storage area AREA1 and store the first access data ACDATA1 in the eight pages. To this end, the controller 130 may generate one piece of first map information MAP1 by mapping the eight logical addresses LP<1:8> corresponding to the first access data ACDATA1 to eight physical addresses B1P1, B1P2, B1P3, B1P4, B1P5, B1P6, B1P7, and B1P8. The eight physical addresses B1P1, B1P2, B1P3, B1P4, B1P5, B1P6, B1P7, and B1P8 correspond to the Nos. 1 to 8 pages P<1:8> of a memory block BLK1, respectively, among the ten memory blocks BLK<1:10>included in the first storage area AREA1. That is, to store the first access data ACDATA1, the controller 130 may newly assign a No. 1 page P1 of a No. 1 memory block BLK1 among the ten memory blocks BLK<1:10>, among the plurality of storage spaces in the first storage area AREA1, for example. The controller 130 does not guarantee, however, sequential access to the eight pages when selecting the eight pages assigned to store the first access data ACDATA1.

According to another embodiment, the host 102 may output the start address LP1, among the eight access logical addresses LP<1:8>, to the controller 130 included in the storage device 110, along with the access command ACCD1 corresponding to a read operation that reads the first access data ACDATA1.

The controller 130 may identify that the first access data ACDATA1 are normal data included in the first storage area AREA1 by identifying that the value of the start address LP1 is included in the first logical address LPN1. Furthermore, the controller 130 may identify the state in which the first access data ACDATA1 have been stored in the eight storage spaces, among the plurality of storage spaces included in the first storage area AREA1, by identifying the state information ACINFO included in the access command ACCD1. That is, the controller 130 may identify that the eight logical addresses LP<1:8> continuously correspond to the first access data ACDATA1 from the start address LP1, using the first logical address LPN1 included in the first map information MAP1.

Accordingly, with reference to the first map information MAP1, the controller 130 may identify the eight physical addresses B1P1, B1P2, B1P3, B1P4, B1P5, B1P6, B1P7, and B1P8 mapped to the eight logical addresses LP<1:8>, respectively, in the first logical address LPN1 corresponding to the first access data ACDATA1 . Furthermore, the controller 130 may read the data of pages indicated by the eight physical addresses B1P1, B1P2, B1P3, B1P4, B1P5, B1P6, B1P7, and B1P8 as the first access data ACDATA1.

FIG. 2B illustrates an example of an operation of at least some values PARTIAL of the first access data ACDATA1 being updated, when the first access data ACDATA1 have been stored in the first storage area AREA1 through an operation illustrated in FIG. 2A.

The host 102 generates values PARTIAL of the first access data ACDATA1 and divides the values PARTIAL of the first access data ACDATA1 by a preset size unit because the host 102 determines that values PARTIAL of the first access data ACDATA1 are normal data, and therefore subsequent access to the values PARTIAL does not require sequential data storage in the storage area. The host 102 generates a plurality of access logical addresses LP<1, 2, 7, 8>, with data at the preset size, to correspond to values PARTIAL.

According to an embodiment, when the values PARTIAL of the first access data ACDATA1 are divided in the units of preset size corresponding to the size of one page, the values PARTIAL are divided into four groups as illustrated in FIG. 2B, and the divided four groups of the values PARTIAL of the first access data ACDATA1 correspond to the four access logical addresses LP<1, 2, 7, 8>.

The host 102 may include state information ACINFO, indicating the state in which the values PARTIAL of the first access data ACDATA1 , that is, normal data, correspond to the four access logical addresses LP<1, 2, 7, 8>, in an access command ACCD2 corresponding to the first access data ACDATA1.

The host 102 may output the four access logical addresses LP<1, 2, 7, 8>and the values PARTIAL of the first access data ACDATA1 to the controller 130 along with the access command ACCD2 corresponding to a write operation.

The controller 130 may identify that the four access logical addresses LP<1, 2, 7, 8> that are input along with the access command ACCD2 corresponding to the write operation are included in the first logical address LPN1 by searching the first map information MAP1 for the four access logical addresses LP<1, 2, 7, 8>. Thus, by identifying the state information ACINFO included in the access command ACCD2, the controller 130 may additionally assign four spaces to store values PARTIAL, which will be used to update values of the first access data ACDATA1 already stored in the four out of eight storage spaces in the first storage area AREA1.

Accordingly, in order to update the first access data ACDATA1 with the values PARTIAL, the controller 130 may assign the four spaces to the values PARTIAL among the storage space in the first storage area AREA1. For example, from the ten memory blocks BLK<1:10> included in the first storage area AREA1, the controller 130 may select Nos. 1 and 2 pages P1 and P2 of the No. 9 memory block BLK9, and Nos. 1 and 2 pages P1 and P2 of the No. 5 memory block BLK5. Then, the controller 130 may update one piece of the first map information MAP1 corresponding to the first access data ACDATA1 by mapping the four logical addresses LP<1, 2, 7, 8> corresponding to the some values PARTIAL of the first access data ACDATA1 to four physical addresses B9P1, B9P2, B5P1, and B5P2. As a result, the controller 130 does not take sequential access into account when selecting four pages used to update the first access data ACDATA1 with the values PARTIAL.

According to another embodiment, the host 102 may output the start address LP1, among the eight access logical addresses LP<1:8>, to the controller 130 included in the storage device 110 along with the access command ACCD1 corresponding to a read operation that reads the first access data ACDATA1.

The controller 130 may identify that the first access data ACDATA1 are normal data included in the first storage area AREA1 by identifying that the value of the start address LP1 input along with the access command ACCD1 corresponding to the read operation is included in the first logical address LPN1. Furthermore, the controller 130 may identify the state in which the first access data ACDATA1 have been stored in eight storage spaces, among the plurality of storage spaces included in the first storage area AREA1, by identifying the state information ACINFO included in the access command ACCD1. That is, the controller 130 may identify that the eight logical addresses LP<1:8> correspond to the first access data ACDATA1 from the start address LP1 in the first logical address LPN1 included in the first map information MAP1.

Accordingly, the controller 130 may identify eight physical addresses B9P1, B9P2, B1P3, B1P4, B1P5, B1P6, B5P1, and B5P2 mapped to eight logical addresses LP<1:8> in the first logical address LPN1 corresponding to the first access data ACDATA1 with reference to the first map information MAP1. Furthermore, the controller 130 may read the data of pages indicated by the eight physical addresses B9P1, B9P2, B1P3, B1P4, B1P5, B1P6, B5P1, and B5P2 identified with reference to the first map information MAP1 as the first access data ACDATA1.

FIGS. 3A and 3B are diagrams for describing examples of operations of accessing, by the storage device, AI data according to an embodiment of the present disclosure.

FIGS. 3A and 3B illustrate examples of operations accessing two AI data ACDATA2 and ACDATA3 generated by a host 102 in a second storage area AREA2 according to an embodiment of the present disclosure.

First, referring to FIG. 3A, the host 102 may generate second access data ACDATA2 and set the second access data ACDATA2 to correspond to one access logical address LP1001 because the second access data ACDATA2 is AI data for which sequential access needs to be guaranteed.

According to an embodiment, the host 102 determines that the size of the second access data ACDATA2 corresponds to a size of eight pages. Accordingly, in the access command ACCD3 corresponding to the second access data ACDATA2, the host 102 may include access information AIINFO indicating that the second access data ACDATA2, that is, AI data, have the size of the eight pages.

Furthermore, the host 102 may output access logical address LP1001 and the second access data ACDATA2 to the controller 130 included in the storage device 110 along with the access command ACCD3 corresponding to a write operation.

The controller 130 may identify that the second access data ACDATA2 are AI data by determining that the access logical address LP1001 is included in a second logical address LPN2, instead of searching the second map information MAP2 for the value of the access logical address LP1001. Furthermore, the controller 130 may assign eight storage spaces, among the plurality of storage spaces included in the second storage area AREA2, to store the second access data ACDATA2 by identifying the access information AIINFO included in the access command ACCD3. In particular, the controller 130 may assign the eight storage spaces, among the plurality of storage spaces included in the second storage area AREA2, as spaces which may be sequentially accessed in a preset order when storing the second access data ACDATA2, that is, AI data.

Accordingly, the controller 130 may select eight pages, among a plurality of pages included in the second storage area AREA2, and store the second access data ACDATA2 in the eight pages. That is, the controller 130 may newly assign a No. 1 page P1 of each of the Nos. 11 to 18 memory blocks BLK<11:18>, among the ten memory blocks BLK<11:20> included in the eight storage spaces, among the plurality of storage spaces included in the second storage area AREA2 to store the second access data ACDATA2. Then, the controller 130 may generate one piece of second map information MAP2 corresponding to the second access data ACDATA2 by mapping the one access logical address LP1001 to eight physical addresses B11P1, B12P1, B13P1, B14P1, B15P1, B16P1, B17P1, and B18P1. The eight physical addresses correspond to the Nos. 1 page P1 of the Nos. 11 to 18 memory blocks BLK<11:18>, from among the ten memory blocks BLK<11:20> included in the second storage area AREA2, because the number of access logical addresses LP1001 set in accordance with the second access data ACDATA2 in the host 102 is one.

In this case, when selecting the eight pages to store the second access data ACDATA2, the controller 130 may guarantee sequential access the eight pages. To this end, the eight physical addresses B11P1, B12P1, B13P1, B14P1, B15P1, B16P1, B17P1, and B18P1 mapped by the controller 130 to the one access logical address LP1001, in accordance with the second access data ACDATA2, may have a form (e.g., pages at the same location in different blocks) in which the eight physical addresses have been sequentially associated in preset order. That is, the controller 130 may manage the eight physical addresses B11P1, B12P1, B13P1, B14P1, B15P1, B16P1, B17P1, and B18P1 mapped to the one access logical address LP1001 in accordance with the second access data ACDATA2 so that the eight physical addresses B11P1, B12P1, B13P1, B14P1, B15P1, B16P1, B17P1, and B18P1 are grouped in a preset order.

According to another embodiment, the host 102 may output the one access logical address LP1001 to the controller 130 included in the storage device 110 along with the access command ACCD3 corresponding to a read operation that reads the second access data ACDATA2.

The controller 130 may identify the second access data ACDATA2 as AI data stored in the second storage area AREA2 using the value of the access logical address LP1001, which is input along with the access command ACCD3 corresponding to the read operation and is included in the second logical address LPN2. Furthermore, the controller 130 may identify the state in which the second access data ACDATA2 have been stored in the eight storage spaces, among the plurality of storage spaces included in the second storage area AREA2, by the access information AIINFO included in the access command ACCD3. That is, the controller 130 may determine that the eight physical addresses B11P1, B12P1, B13P1, B14P1, B15P1, B16P1, B17P1, and B18P1 correspond to the second access data ACDATA2, and that the eight physical addresses are mapped to the one access logical address LP1001 of the second logical address LPN2 included in the second map information MAP2, and are grouped in a preset order.

Accordingly, the controller 130 may read the data of pages indicated by the eight physical addresses B11P1, B12P1, B13P1, B14P1, B15P1, B16P1, B17P1, and B18P1 corresponding to the second access data ACDATA2 in the preset order with reference to the second map information MAP2.

Furthermore, referring to FIG. 3B, in the state in which the second access data ACDATA2 have been stored in the second storage area AREA2 through the operation of FIG. 3A, the host 102 may generate third access data ACDATA3, that is, new AI data. The host 102 may associate the third access data ACDATA3 with one access logical address LP1002 when the third access data ACDATA3 are AI data to which sequential access needs to be guaranteed.

According to an embodiment, the host 102 processes third access data ACDATA3, where the size of the third access data ACDATA3 corresponds to the size of ten pages. Accordingly, the host 102 may include access information AIINFO indicating the of the third access data ACDATA3, that is, ACDATA3 is AI data with the size of the ten pages. Access information AIINFO is included in the access command ACCD4 corresponding to the third access data ACDATA3.

Furthermore, the host 102 may output the access logical address LP1002 and the third access data ACDATA3 to the controller 130 included in the storage device 110 along with an access command ACCD4 corresponding to a write operation.

The controller 130 may identify that the third access data ACDATA3 are AI data by determining that the access logical address LP1002 is included in the second logical address LPN2, instead of searching the second map information MAP2 for the value of the access logical address LP1002. Furthermore, the controller 130 may assign ten storage spaces, among the plurality of storage spaces included in the second storage area AREA2, to store the third access data ACDATA3 by identifying the access information AIINFO included in the access command ACCD4. In particular, the controller 130 may assign the ten storage spaces, among the plurality of storage spaces included in the second storage area AREA2, as spaces which may be sequentially accessed in a preset order when storing the third access data ACDATA3, that is, AI data.

Accordingly, the controller 130 may select ten pages, among a plurality of pages included in the second storage area AREA2, and may store the third access data ACDATA3 in the ten pages. That is, the controller 130 may assign a No. 2 page P2 of each of the ten memory blocks BLK<11:20> included in the ten storage spaces, among the plurality of storage spaces in the second storage area AREA2, to store the third access data ACDATA3. Then, the controller 130 may generate one piece of second map information MAP2 corresponding to the third access data ACDATA3 by mapping the one access logical address LP1002 to the Nos. 2 page P2 of the ten memory blocks BLK<11:20> included in the second storage area AREA2. Ten physical addresses correspond to the Nos. 2 page P2 of the ten memory blocks BLK<11:20> because the number of access logical addresses LP1002 set in accordance with the third access data ACDATA3 by the host 102 is one.

In this case, when selecting the ten pages to store the third access data ACDATA3, the controller 130 may guarantee sequential access to the ten pages. To this end, ten physical addresses B11P2, B12P2, B13P2, B14P2, B15P2, B16P2, B17P2, B18P2, B19P2, and B20P2 that are mapped by the controller 130 to the one access logical address LP1002, in accordance with the third access data ACDATA3, may have a form (e.g., pages at the same location in different blocks) in which the ten physical addresses B11P2, B12P2, B13P2, B14P2, B15P2, B16P2, B17P2, B18P2, B19P2, and B20P2 have been sequentially associated in preset order. That is, the controller 130 may manage the ten physical addresses B11P2, B12P2, B13P2, B14P2, B15P2, B16P2, B17P2, B18P2, B19P2, and B20P2 mapped to the one access logical address LP1002 in accordance with the third access data ACDATA3 so that the ten physical addresses B11P2, B12P2, B13P2, B14P2, B15P2, B16P2, B17P2, B18P2, B19P2, and B20P2 are grouped in a preset order.

According to another embodiment, the host 102 may output the one access logical address LP1002 to the controller 130 included in the storage device 110 along with the access command ACCD4 corresponding to a read operation that reads the third access data ACDATA3.

The controller 130 may identify the third access data ACDATA3 as AI data stored in the second storage area AREA2 using the value of the access logical address LP1002, which is input along with the access command ACCD4 corresponding to the read operation and is included in the second logical address LPN2. Furthermore, the controller 130 may identify the state in which the third access data ACDATA3 have been stored in the ten storage spaces, among the plurality of storage spaces included in the second storage area AREA2, through the access information AIINFO included in the access command ACCD4. That is, the controller 130 may determine that the ten physical addresses B11P2, B12P2, B13P2, B14P2, B15P2, B16P2, B17P2, B18P2, B19P2, and B20P2 correspond to the third access data ACDATA3, and that the ten physical addresses are mapped to the one access logical address LP1002 of the second logical address LPN2 included in the second map information MAP2, and are grouped in a preset order.

Accordingly, the controller 130 may read the data of pages indicated by the ten physical addresses B11P2, B12P2, B13P2, B14P2, B15P2, B16P2, B17P2, B18P2, B19P2, and B20P2 corresponding to the third access data ACDATA3 in the preset order with reference to the second map information MAP2.

For reference, in embodiments of the present disclosure, the state in which a boundary value of 1000 is assumed for each of the first logical address LPN1 and the second logical address LPN2. That is, in an embodiment of the present disclosure, it may be assumed that when the value of an access logical address is greater than 1000, access data corresponding to the access logical address are AI data. In contrast, when the value of an access logical address is 1000 or less, access data corresponding to the access logical address are normal data. Applying these assumptions to the descriptions of FIGS. 2A-3B above, FIGS. 2A and 2B exemplify that the value of the logical address that is input from the host 102 to the controller 130 is 1000 or less (1 to 8), and FIGS. 3A and 3B exemplify that the value of the logical address that is input from the host 102 to the controller 130 is greater than 1000 (1001 and 1002). The aforementioned embodiments are for convenience of description here, and embodiments may be implemented in different ways depending on a designer's choice.

Furthermore, the one access logical address LP1001 corresponding to the second access data ACDATA2 described with reference to FIG. 3A and the one access logical address LP1002 corresponding to the third access data ACDATA3 described with reference to FIG. 3B may each have a consecutive value as in FIGS. 3A and 3B, but may each have a discontinuous value.

Furthermore, when a plurality of physical addresses B11P1, B12P1, B13P1, B14P1, B15P1, B16P1, B17P1, B18P1 or B11P2, B12P2, B13P2, B14P2, B15P2, B16P2, B17P2, B18P2, B19P2, and B20P2 is mapped to the one logical address LP1001 or LP1002 as illustrated in FIGS. 3A and 3B, all of the values of the physical addresses may be stored in the second map information MAP2, but the value of each of the physical addresses may be compressed into a specific form (e.g., a start physical address +offset) and stored in the second map information MAP2.

Embodiments in which the plurality of storage spaces included in the second storage area AREA2 are assumed to be implemented in page units have been described with reference to FIGS. 3A and 3B, but this is merely for convenience of description. In other embodiments, storage spaces included in the second storage area AREA2 may be implemented in zone units. A zone unit refers to a unit that supports only a sequential write operation by grouping at least one memory block, and therefore the zone unit may be suitable for managing AI data having a very large size because only a sequential write operation is forced. Unlike the embodiments described in FIGS. 3A and 3B, in order to manage the plurality of storage spaces as zone units included in the second storage area AREA2, the host may directly manage the second map information MAP2. For reference, data management technology using zone units is an already known technology, and therefore will not be described more specifically here.

FIGS. 4A and 4B are diagrams for describing examples of operations of updating, by the storage device, AI data according to an embodiment of the present disclosure.

FIGS. 4A and 4B may illustrate examples of operations of updating at least some 1^{st} AI data ACDATA2 data PARTIAL in the state in which the two AI data ACDATA2 and ACDATA3 generated by the host 102 through the operation of FIGS. 3A and 3B have been stored in the second storage area AREA2.

The host 102 generates values PARTIAL of the second access data ACDATA2 associates values PARTIAL of the second access data ACDATA2 with one access logical address LP1001 because the host 102 has determined that the values PARTIAL of the second access data ACDATA2 are AI data to which sequential access is required.

According to an embodiment, a total size of the second access data ACDATA2 stored in the second storage area AREA2 in FIG. 3A corresponds to the size of eight pages, the values PARTIAL of the second access data ACDATA2, that is, an update target, corresponds to the size of two pages. Furthermore, the location of pages corresponding to values PARTIAL within the second access data ACDATA2, which has eight pages, is known. Accordingly, the host 102 may generate access information AIINFO indicating that the values PARTIAL of the second access data ACDATA2, that is, AI data, has the size of the two pages and that the values PARTIAL have a known location within the eight pages of second access data ACDATA2. The host 102 may include the access information AIINFO in the access command ACCD3 corresponding to the second access data ACDATA2.

Furthermore, the host 102 may output the one access logical address LP1001 and the values PARTIAL of the second access data ACDATA2 to the controller 130 included in the storage device 110 along with an access command ACCD5 corresponding to a write operation.

The controller 130 may determine that the one access logical address LP1001 is included in the second logical address LPN2 by searching the second map information MAP2 for the one access logical address LP1001, which is input along with the access command ACCD5 corresponding to the write operation. The controller 130 may determine that two values stored in Nos. 1 and 2 spaces in the second access data ACDATA2, which is stored in eight storage spaces, need to be updated with the values PARTIAL. Furthermore, the controller 130 may determine that the other six values stored in the remaining Nos. 3 to 8 need to be maintained without updating by analyzing the access information AIINFO included in the access command ACCD5.

The controller 130 may assign the eight different storage spaces, among the plurality of storage spaces included in the second storage area AREA2, for the update operation in which the values PARTIAL are used to update some of the second access data ACDATA2. The eight storage spaces are selected from different spaces in the second storage area AREA2 and configured to be sequentially accessed in a preset order.

For example, the controller 130 may determine that the values of Nos. 1 and 2 of the physical addresses, B11P1 and B12P1, correspond to LP1001, which is the value of the access logical address retrieved in the second map information MAP2. That is, the controller 130 may determine that spaces of the second storage area AREA2 that require substitution are Nos. 1 page P1 of eleventh and twelfth memory blocks BLK<11:12> as illustrated in FIG. 3A.

Accordingly, the controller 130 may select a total of eight different target spaces in a free state in the second storage area AREA2. Two of the eight target spaces are selected in the eleventh and twelfth memory blocks BLK<11:12>, respectively, as substitution spaces for the values PARTIAL. All of the eight target spaces are selected to be accessible in sequence in a preset order.

That is, as illustrated in FIG. 4A, the controller 130 may select the eight free target spaces in the second storage area AREA2, including two target spaces Nos. 3 page P3 of the eleventh and twelfth memory blocks BLK<11:12>, and six target spaces the Nos. 3 page P3 of the Nos. 13 to 18 memory blocks BLK<13:18>. The eight selected target spaces may be sequentially accessed in a preset order. Furthermore, the controller 130 may select the Nos. 3 page P3 of the eleventh and twelfth memory blocks BLK<11:12> to store the some values PARTIAL, and six target spaces the Nos. 3 page P3 of the Nos. 13 to 18 memory blocks BLK<13:18> to store the other six spaces of ACDATA2 that do not require updating, namely, Nos. 2 page P2 of the Nos. 13 to 18 memory blocks BLK<13:18>.

The controller 130 may update one piece of the second map information MAP2 corresponding to the second access data ACDATA2 by mapping the one access logical address LP1001, which corresponds to the second access data ACDATA2, to eight physical addresses B11P3, B12P3, B13P3, B14P3, B15P3, B16P3, B17P3, and B18P3. The eight physical addresses correspond to the Nos. 3 page P3 of the Nos. 11 and 18 memory blocks BLK<11:18>, respectively, among the ten memory blocks BLK<11:20>included in the second storage area AREA2.

As another example, after identifying that the spaces that require data substitution in the second storage area AREA2 are the Nos. 1 page P1 of the eleventh and twelfth memory blocks BLK<11:12>, the controller 130 may select a total of eight different target spaces in a free state in the second storage area AREA2. The controller 130 may select two pages in a free state in the Nos. 19 and 20 memory blocks BLK<19:20> as two of the eight target spaces. The two pages are at physical locations that are different from the spaces used to store the data for substitution. The remaining six pages of the eight target spaces are selected such that all eight pages corresponding to the eight target spaces can be sequentially accessed in a preset order.

For example, as illustrated in FIG. 4B, the controller 130 may select a total of eight free target spaces in the second storage area AREA2, including two target spaces the Nos. 3 page P3 of the Nos. 19 and 20 memory blocks BLK<19:20>, and six target spaces Nos. 3 page P3 of the Nos. 13 to 18 memory blocks BLK<13:18>. The eight selected target spaces may be sequentially accessed in a preset order. Furthermore, the controller 130 may select Nos. 3 page P3 of the Nos. 19 and 20 memory blocks BLK<19:20> to store the data for updating, values PARTIAL, and may select Nos. 3 page P3 of the Nos. 13 to 18 memory blocks BLK<13:18>to store the other six spaces of ACDATA2 that do not require updating, namely, Nos. 2 page P2 of the Nos. 13 to 18 memory blocks BLK<13:18>.

The controller 130 may update one piece of the second map information MAP2 corresponding to the second access data ACDATA2 by mapping the one access logical address LP1001, which corresponds to the second access data ACDATA2, to the eight physical addresses B13P3, B14P3, B15P3, B16P3, B17P3, B18P3, B19P3, and B20P3. The eight physical addresses correspond to the Nos. 3 page P3 of the Nos. 13 and 20 memory blocks BLK<13:20>, from the ten memory blocks BLK<11:20>included in the second storage area AREA2.

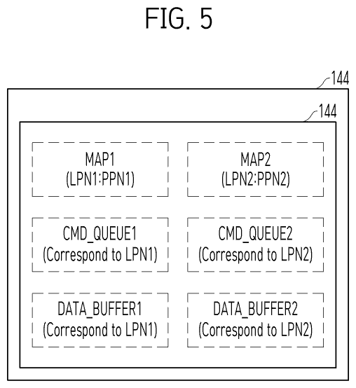

FIG. 5 is a diagram for describing an example of an operation of managing, by the controller included in a storage device, an internal memory space according to an embodiment of the present disclosure.

Referring to FIG. 5, a controller 130 included in a storage device 110 according to an embodiment of the present disclosure may include a first command queue CMD_QUEUE1, a second command queue CMD_QUEUE2, a first data buffer DATA_BUFFER1, and a second data buffer DATA_BUFFER2.

When the value of an access logical address that is input along with an access command from the host 102 is included in the first logical address LPN1, the first command queue CMD_QUEUE1 may queue the access command. That is, the controller 130 may manage an access command that accesses normal data in the first command queue CMD_QUEUE1.

Furthermore, the first data buffer DATA_BUFFER1 may buffer normal data. That is, the first data buffer DATA_BUFFER1 may be used to buffer only normal data corresponding to the access command that is managed in the first command queue CMD_QUEUE1, and does not buffer AI data.

When the value of the access logical address that is input along with the access command from the host 102 is included in the second logical address LPN2, the second command queue CMD_QUEUE2 may queue the access command. That is, the controller 130 may manage an access command that accesses AI data in the second command queue CMD_QUEUE2.

Furthermore, the second data buffer DATA_BUFFER2 may buffer the AI data. That is, the second data buffer DATA_BUFFER2 may be used to buffer only the AI data corresponding to the access command that is managed in the second command queue CMD_QUEUE2, and does not buffer normal data.

As described above, the controller 130 according to an embodiment of the present disclosure may independently manage an access operation for normal data and an access operation for AI data by separating the access operations through the first command queue CMD_QUEUE1, the first data buffer DATA_BUFFER1, the second command queue CMD_QUEUE2, and the second data buffer DATA_BUFFER2.

It will be evident to a person having ordinary knowledge in the art to which the present disclosure pertains that the present disclosure described above is not limited by the aforementioned embodiments and the accompanying drawings and that the present disclosure may be substituted, modified, and changed in various ways without departing from the technical spirit of the present disclosure.

What is claimed is:

1. A storage device comprising:
a nonvolatile memory device comprising first and second storage areas; and
a controller
configured to manage first map information that separately maps first data, divided by a preset size unit, in order to access the first storage area by preset size units when access to the first data is requested,
configured to manage N pieces of second map information that separately maps N second data, and
configured to access the second storage area by a size of each of the N second data when access to the N second data is requested,
wherein N is a natural number equal to or greater than 1.

2. The storage device of claim 1, wherein the controller sequentially selects at least two storage spaces, from among a plurality of storage spaces included in the second storage area, in which the N second data are to be accessed in a preset order by using an access information included in a received access command.

3. The storage device of claim 2, wherein:
the controller sequentially writes the N second data in the at least two storage spaces in the preset order in response to a first write command, and
a second map information corresponding to a written N second data, among the N pieces of second map information, is information by which at least two physical addresses corresponding to the at least two storage spaces are mapped to one logical address corresponding to the written N second data in the preset order.

4. The storage device of claim 3, wherein the controller
receives, with a second write command, substitution values to update the written N second data in some of the at least two storage spaces without updating a remainder of the written N second data,
selects substitution spaces and stores the substitution values in the substitution spaces,
references access information included in the second write command and the second map information when receiving a command to update the written N data in the at least two of the storage spaces with the substitution values,
selects target spaces in a free state, which are included in the second storage area,
copies the substitution values from the substitution spaces to the target spaces and the remainder of the written N second data to the remaining target spaces, and
updates one logical address corresponding to the written N data in the second map information with the updated written N data by mapping the one logical address to a physical address of the target spaces.

5. The storage device of claim 4, wherein the controller selects the target spaces to be sequentially accessed in the preset order.

6. The storage device of claim 2, wherein the controller separately and independently manages a plurality of storage spaces included in the first storage area and the plurality of storage spaces included in the second storage area so that the plurality of storage spaces included in the first storage area and the plurality of storage spaces included in the second storage area are not exchanged with each other or not continuous to each other.

7. The storage device of claim 6, wherein when a value of an access logical address that is input along with the access command is included in a first logical address, the controller selects an access target space, among the plurality of storage spaces included in the first storage area, with reference to state information included in the access command corresponding to the access logical address and the first map information.

8. The storage device of claim 7, wherein when the value of the access logical address is included in N second logical addresses that do not overlap the first logical address, the controller selects the at least two storage spaces with reference to access information included in the access command corresponding to the access logical address and the N pieces of second map information.

9. The storage device of claim 8, wherein the controller comprises:
a first command queue configured to manage the access command corresponding to the access logical address included in the first logical address, and
a second command queue configured to manage the access command corresponding to the access logical address included in the second logical address.

10. A data processing system comprising:
a host configured to separately manage first data organized in units of a preset size and configured to separately manage N second data in which second data size varies; and
a storage device comprising a nonvolatile memory device comprising first and second storage areas and a controller
configured to manage first map information that separately maps the first data in preset size units to access the first storage area organized in units of the preset size when access to the first data is requested by the host, and
configured to manage N pieces of second map information that separately map the N second data in order to access the second storage area by a size of each of the N second data when access to the N second data is requested by the host,
wherein N is a natural number equal to or greater than 1.

11. The data processing system of claim 10, wherein the host generates an access command that requests access to selection data, which is the N second data targeted by the access command, from the storage device by including access information indicative of a size of the selection data within the access command.

12. The data processing system of claim 11, wherein when receiving the access command that accesses the selection data from the host, the controller sequentially selects at least two selection spaces in which the selection data are to be accessed, among a plurality of plurality of storage spaces included in the second storage area, by identifying the access information included in the received access command.

13. The data processing system of claim 12, wherein:
the controller sequentially writes the selection data in the at least two selection spaces in a preset order in response to a first write command received from the host, and
selection map information corresponding to the selection data, among the N pieces of second map information, is information by which at least two physical addresses corresponding to the at least two selection spaces are mapped to one logical address corresponding to the selection data in the preset order.

14. The data processing system of claim 13, wherein the controller
receives a substitution value to update data in some of the at least two selection spaces,
selects a substitution space with reference to access information included in a second write command and the selection map information,
selects a target space in a free state, which is included in the plurality of storage spaces included in the second storage area,
copies the substitution value to the target space and values of a remainder of the at least two selection spaces that are not updated, and
updates one logical address corresponding to the selection data in the selection map information with the selection data after the data update by mapping the one logical address to a physical address of the target space.

15. The data processing system of claim 14, wherein the controller selects target spaces to be sequentially accessed in the preset order.

16. The data processing system of claim 12, wherein the host
divides the first data by the preset size and manages the first data by associating the divided first data with a plurality of first logical addresses,
manages the N second data associating the N second data with N second logical addresses, and
manages the plurality of first logical addresses and the N second logical addresses separately and independently so that the plurality of first logical addresses and the N second logical addresses are not exchanged or not continuous to each other.

17. The data processing system of claim 16, wherein the controller separately and independently manages a plurality of storage spaces included in the first storage area and the plurality of storage spaces included in the second storage area so that the plurality of storage spaces included in the first storage area and the plurality of storage spaces included in the second storage area are not exchanged or not continuous to each other.

18. The data processing system of claim 17, wherein when a value of an access logical address that is input along with the access command from the host is included in a first logical address, the controller selects an access target space, from among the plurality of storage spaces included in the first storage area, with reference to state information included in the access command corresponding to the access logical address and the first map information.

19. The data processing system of claim 18, wherein when the value of the access logical address is included in the N second logical addresses, the controller selects the at least two selection spaces with reference to access information included in the access command corresponding to the access logical address and the N pieces of second map information.

20. The data processing system of claim 19, wherein the controller comprises:
a first command queue configured to manage the access command corresponding to the access logical address included in the first logical address, and
a second command queue configured to manage the access command corresponding to the access logical address included in the second logical address.
